(19) United States
(12) Patent Application Publication
(10) Pub. No.: US 2010/0282465 A1
(43) Pub. Date: Nov. 11, 2010

(54) Methods of consolidating particulates using a hardenable resin and an orgaosilane coupling agent

(75) Inventors: Jimmie D. Weaver, Duncan, OK (US); Phillip D. Nguyen, Duncan, OK (US)

Correspondence Address: ROBERT A. KENT, P.O. BOX 1431, DUNCAN, OK, 73536, US

(73) Assignee: Halliburton Energy Services, Inc.

(21) Appl. No.: 12/387,876

(22) Filed: May 8, 2009

(51) Int. Cl. C09K 8/56; E21B 33/13; C09K 8/42

(52) U.S. Cl. 166/293

(57) ABSTRACT

Improved methods for consolidating particulates in subterranean formations wherein the particulates are consolidated using curable resins that require the use of a hardening agent in order to cure. The improved methods use an organosilane coupling agent to increase adhesion of the curable resin to inorganic surfaces, such as proppant particulates or rock surfaces, and to act as a resin hardening agent.

### BACKGROUND OF THE INVENTION

1. Field of the Invention

The present invention relates to improved methods for consolidating particulates in subterranean formations. More particularly, the present invention relates to the use of an organosilane coupling agent to increase adhesion and to act as a resin hardening agent.

2. Description of the Prior Art

In addition to unconsolidated particulates that occur naturally in a subterranean formation, often subterranean formations are subjected to treatments that insert particulates at or near a production zone. One such treatment is hydraulic fracturing. In hydraulic fracturing treatments, a viscous fracturing fluid, which also functions as a carrier fluid, is pumped into a producing zone to be fractured at a rate and pressure such that one or more fractures are formed in the zone. Particulate solids commonly referred to in the art as “proppant,” are commonly suspended in a portion of the fracturing fluid so that the proppant is deposited in the fractures. The proppant deposited in the fractures functions to prevent the fractures from fully closing so that conductive channels are formed through which produced hydrocarbons may flow. Generally, the force of the formation bearing down on the proppant acts to keep the proppant in place. However, it is often the case that not all of the proppant will be effectively trapped by the pressure of the formation. For instance, some proppant particulates may break free of the proppant pack with the force of the produced fluids, or some portion of the proppant particulates may crush under the pressure of the formation and create unconsolidated particulates.

Gravel packs may also act to add particulates into a portion of a subterranean formation. A “gravel pack” is a term commonly used to refer to a volume of particulate materials (such as sand) placed into a well bore to at least partially reduce the migration of unconsolidated formation particulates into the well bore. Gravel packing operations commonly involve placing a gravel pack screen in the well bore neighboring a desired portion of the subterranean formation, and packing the surrounding annulus between the screen and the subterranean formation with particulate materials that are sized to prevent and inhibit the passage of formation solids through the gravel pack with produced fluids. In some instances, a screenless gravel packing operation may be performed. In either case, the resulting structure presents a barrier to migrating formation particles, and stabilizes the formation, while still permitting fluid flow. The gravel, among other things, is designed to prevent the particulates from occluding the screen or migrating with the produced fluids, and the screen acts to prevent the gravel from entering the well bore. However, it is possible for gravel to escape from the confines of the pack or for the gravel pack to bridge or otherwise fail to fully halt the flow of unconsolidated particulates into the well bore.

In addition to maintaining a relatively solids-free production stream, consolidating particulates also aids in protecting the conductivity of the formation. Flow of unconsolidated particulate material through the conductive channels in a subterranean formation may tend to clog the conductive channels and/or damage the interior of the formation or may erode downhole equipment, plug piping and vessels, and cause damage to valves, instruments and other production equipment. For these among other reasons, it is desirable to consolidate unconsolidated particulates within a producing zone in a subterranean formation.

There are several known techniques used to control particulate migration, some of which involve the use of consolidating agents. For example, a portion of particulates introduced into a subterranean formation may be coated with a hardenable resin composition that is caused to harden and consolidate the particulates. One commonly used resin system is a two-component system that employs a hardenable resin and a liquid hardening agent. Use of these systems is made problematic by the fact that they may be difficult to coat onto particulates and that it can be difficult to control when and where the hardening agent comes into contact with the hardenable resin. Often, the hardenable resin and the hardening agent must be pre-mixed to form a mixture prior to the treatment in order to ensure the effectiveness of treatment. However, if the hardenable resin and the hardening agent come in contact at the wrong time or location, high quality downhole consolidation may not result as desired. Moreover, hardening agents aid in resin consolidation but to not improve resin placement onto desired inorganic substrates such as particulates.

### SUMMARY OF THE INVENTION

The present invention relates to improved methods for consolidating particulates in subterranean formations. More particularly, the present invention relates to the use of an organosilane coupling agent to increase adhesion and to act as a resin hardening agent.

Some embodiments of the methods of the present invention comprises using particulates with a resin coating capable of method of using particulates with a resin coating capable of hardening in a subterranean operation comprising the steps of: providing particulates, an organosilane coupling agent, a carrier fluid, and a curable resin, wherein the curable resin requires an external hardening agent in order to cure; coating the particulates with the organosilane coupling agent to create organosilane-coated particulates; coating the organosilane-coated particulates with the curable resin to create hardenable resin-coated particulates; creating a slurry of hardenable resin-coated particulates in the carrier fluid; and, placing the slurry into a portion of a subterranean formation and allowing the organosilane coupling agent to cure the hardenable resin to form cured, resin-coated particulates.

Other embodiments of the present invention provide methods of consolidating particulates with a resin coating capable of hardening in a subterranean environment comprising the steps of: providing particulates, an organosilane coupling agent, a carrier fluid, and a curable resin, wherein the curable resin requires an external hardening agent in order to cure; coating the particulates with the organosilane coupling agent to create organosilane-coated particulates; creating a slurry of organosilane-coated particulates in the carrier fluid wherein the carrier fluid comprises the curable resin and allowing the organosilane coupling agent to preferentially attract the curable resin to the organosilane-coated particulates; placing the slurry into a portion of a subterranean formation and allowing the organosilane coupling agent to cure the hardenable resin to form cured, resin-coated particulates.

Still other embodiments of the present invention provide methods of consolidating particulates within a portion of a subterranean formation comprising the steps of: placing a first flush fluid comprising an organosilane coupling agent into a portion of a subterranean formation comprising particulates and allowing the organosilane coupling agent to coat at least a portion of the particulates; placing a second flush fluid comprising a curable resin, wherein the curable resin requires an external hardening agent in order to cure, into at least a portion of the subterranean formation where the first flush fluid was previously placed; allowing the organosilane coupling agent to attract the curable resin and to cure the curable resin on the particulate surfaces within the subterranean formation to form cured, resin-coated particulates.

The features and advantages of the present invention will be apparent to those skilled in the art. While numerous changes may be made by those skilled in the art, such changes are within the spirit of the invention.

### DESCRIPTION OF PREFERRED EMBODIMENTS

The present invention relates to improved methods for consolidating particulates in subterranean formations. More particularly, the present invention relates to the use of an organosilane coupling agent to increase adhesion and to act as a resin hardening agent.

One embodiment of the improved methods of the present invention provides a method of using particulates coated with a resin that is capable of hardening (curing) in a subterranean environment wherein the particulates to are first coated with an organosilane coupling agent (about 0.1 to about 2% volume by weight of proppant, preferably about 1% v/w) and then coated with a liquid hardenable resin (about 0.1 to about 5% volume by weight of proppant, preferably about 3% v/w) that requires an external hardening agent in order to cure. The organosilane and resin-coated particulates are then suspended in a carrier fluid to form a slurry and placed into a desired location within a subterranean formation. The organosilane coupling agent acts as a bonding agent that improves the ability of the resin to coat and remain on the surface of the particulate. Moreover, the organosilane coupling agent has been found to be capable of acting as a hardening agent that is capable of curing the hardenable resin such that no additional liquid hardening agent is required.

A second embodiment of the improved methods of the present invention provides method of using particulates coated with a resin that is capable of hardening (curing) wherein particulates are coated with an organosilane coupling agent (about 0.1 to about 2% volume by weight of proppant, preferably about 1% v/w) and then suspended into a carrier fluid. In these embodiments, the carrier fluid includes a liquid hardenable resin (about 0.1 to about 5% volume by weight of proppant, preferably about 3% v/w) that requires an external hardening agent in order to cure. The slurry is then placed into a desired location within a subterranean formation. The organosilane coupling agent acts to attract the liquid hardenable resin onto the surface of the particulates; thus the hardenable resin then has a tendency to adhere to the surface of the organosilane-coated particulates rather than on other particulates it may encounter in the subterranean formation. As noted above, the organosilane coupling agent itself acts as a hardening agent that is capable of curing the hardenable resin. In some preferred embodiments it may be preferable to maintain the slurry comprising the resin and organosilane-coated particulates for a period of time before placing the slurry into the subterranean formation to increase the percentage of liquid hardenable resin that is attracted to the organosilane-coated particulates as opposed to other particulates the slurry may encounter once placed in the subterranean formation.

A third embodiment may be used to consolidate formation particulates already resident in a formation—these particulates may be either naturally occurring (such as formation sands) or may have been previously placed into the formation (such as a gravel pack or proppant). In these embodiments, a flush fluid comprising an organosilane coupling agent (about 0.01 to about 3% volume by volume of flush fluid, preferably about 0.1 to about 1.5% v/v) is placed into a portion of a subterranean formation having unconsolidated or loosely consolidated particulates. The organosilane coupling agent tends to preferentially adhere to loose formation sands comprising silica. After the organosilane coupling agent is placed, a second flush fluid comprising a liquid hardenable resin component (about 0.01 to about 10% weight by volume of second flush fluid, preferably about 0.1 to about 5% w/v) that requires an external hardening agent in order to cure is placed. The second flush fluid is placed into substantially the same area of the subterranean formation as the first flush fluid comprising the organosilane coupling agent. As noted above, liquid hardenable resins suitable for use in the present invention tend to be attracted to organosilane coupling agents. The organosilane coupling agent acts as a bonding agent that improves the ability of the resin to coat and remain on the surface of the particulate. For this reason, the liquid hardenable resin in the carrier fluid preferentially coats the surfaces of the formation coated with the organosilane coupling agent. Moreover, as noted above, the organosilane coupling agent has been found to be capable of acting as a hardening agent that is capable of curing the hardenable resin, and no additional liquid hardening agent is required.

A fourth embodiment can also be used to consolidate formation particulates already resident in a formation—these particulates may be either naturally occurring (such as formation sands) or may have been placed there (such as a gravel pack or proppant). In these embodiments, a flush fluid comprising both an organosilane coupling agent (about 0.01 to about 3% volume by volume of flush fluid, preferably about 0.1 to about 1.5% v/v) and a liquid hardenable resin (about 0.01 to about 10% weight by volume of flush fluid, preferably about 0.1 to about 5% w/v) is placed into a portion of a subterranean formation having unconsolidated or loosely consolidated particulates. As noted above, the organosilane coupling agent both acts to bind the resin to inorganic surfaces and acts to the substantially cure the resin.

Thus, the methods of the present invention may allow for the placement of a one-part resin system; that is, a resin system that does not require the application of a hardener in order for the resin to substantially cure. In addition, methods that allow an organosilane coupling agent to bond with particulates or rock surfaces before being exposed to resin allow for more efficient use of the organosilane coupling agent. This is due, at least in part, to the fact that when an organosilane coupling agent is combined with an uncured resin, the long resin molecules may tend to bond to the organosilane coupling agent's organic functional groups thereby entangling the silane functional group so that it is not available to perform its function of binding to an inorganic surface such as rock or proppant.

### A. Carrier Fluids, Flush Fluids, and Particulates.

Generally, any carrier fluid suitable for a subterranean application such as fracturing, graveling packing, or frac-packing application may be used in accordance with the teachings of the present invention, including aqueous gels, viscoelastic surfactant gels, oil gels, foamed gels and emulsions. Suitable aqueous gels are generally comprised of water and one or more gelling agents. Suitable emulsions can be comprised of two immiscible liquids such as an aqueous liquid or gelled liquid and a hydrocarbon. Foams may be created by the addition of a gas, such as carbon dioxide or nitrogen. In exemplary embodiments of the present invention, the carrier fluids are aqueous gels comprised of water, a gelling agent for gelling the water and increasing its viscosity, and, optionally, a crosslinking agent for crosslinking the gel and further increasing the viscosity of the fluid. The increased viscosity of the gelled, or gelled and cross-linked, carrier fluid may, among other things, reduce fluid loss and allow the carrier fluid to transport significant quantities of suspended proppant particles. The water used to form the carrier fluid may be fresh water, salt water, brine, sea water, or any other aqueous liquid that does not adversely react with the other components. The density of the water can be increased to provide additional particle transport and suspension in the present invention. The preferred carrier fluids for use in accordance with this invention are aqueous gels comprised of water, a gelling agent for gelling the water and increasing its viscosity, and optionally, a cross-linking agent for cross-linking the gel and further increasing the viscosity of the fluid.

A variety of gelling agents may be used, including hydratable polymers that contain one or more functional groups such as hydroxyl, carboxyl, sulfate, sulfonate, amino, or amide groups. Suitable gelling typically comprise polymers, synthetic polymers, or a combination thereof. A variety of gelling agents can be used in conjunction with the methods and compositions of the present invention, including, but not limited to, hydratable polymers that contain one or more functional groups such as hydroxyl, cis-hydroxyl, carboxylic acids, derivatives of carboxylic acids, sulfate, sulfonate, phosphate, phosphonate, amino, or amide. In certain exemplary embodiments, the gelling agents may be polymers comprising polysaccharides, and derivatives thereof that contain one or more of these monosaccharide units: galactose, mannose, glucoside, glucose, xylose, arabinose, fructose, glucuronic acid, or pyranosyl sulfate. Examples of suitable polymers include, but are not limited to, guar gum and derivatives thereof, such as hydroxypropyl guar and carboxymethylhydroxypropyl guar, and cellulose derivatives, such as hydroxyethyl cellulose. Additionally, synthetic polymers and copolymers that contain the above-mentioned functional groups may be used. Examples of such synthetic polymers include, but are not limited to, polyacrylate, polymethacrylate, polyacrylamide, polyvinyl alcohol, and polyvinylpyrrolidone. In other exemplary embodiments, the gelling agent molecule may be depolymerized. The term “depolymerized,” as used herein, generally refers to a decrease in the molecular weight of the gelling agent molecule. Depolymerized gelling agent molecules are described in U.S. Pat. No. 6,488,091 issued Dec. 3, 2002 to Weaver, et al., the relevant disclosure of which is incorporated herein by reference. Suitable gelling agents generally are present in the viscosified carrier fluids of the present invention in an amount in the range of from about 0.1% to about 5% by weight of the water therein. In certain exemplary embodiments, the gelling agents are present in the viscosified carrier fluids of the present invention in an amount in the range of from about 0.01% to about 2% by weight of the water therein.

Crosslinking agents may be used to crosslink gelling agent molecules to form crosslinked gelling agents. Crosslinkers typically comprise at least one ion that is capable of crosslinking at least two gelling agent molecules. Examples of suitable crosslinkers include, but are not limited to, boric acid, disodium octaborate tetrahydrate, sodium diborate, pentaborates, ulexite and colemanite, compounds that can supply zirconium IV ions (such as, for example, zirconium lactate, zirconium lactate triethanolamine, zirconium carbonate, zirconium acetylacetonate, zirconium malate, zirconium citrate, and zirconium diisopropylamine lactate); compounds that can supply titanium IV ions (such as, for example, titanium lactate, titanium malate, titanium citrate, titanium ammonium lactate, titanium triethanolamine, and titanium acetylacetonate); aluminum compounds (such as, for example, aluminum lactate or aluminum citrate); antimony compounds; chromium compounds; iron compounds; copper compounds; zinc compounds; or a combination thereof. An example of a suitable commercially available zirconium-based crosslinker is “CL-24” available from Halliburton Energy Services, Inc., Duncan, Okla. An example of a suitable commercially available titanium-based crosslinker is “CL-39” available from Halliburton Energy Services, Inc., Duncan Okla. Suitable crosslinkers generally are present in the viscosified carrier fluids of the present invention in an amount sufficient to provide, inter alia, the desired degree of crosslinking between gelling agent molecules. In certain exemplary embodiments of the present invention, the crosslinkers may be present in an amount in the range from about 0.001% to about 10% by weight of the water in the carrier fluid. In certain exemplary embodiments of the present invention, the crosslinkers may be present in the viscosified carrier fluids of the present invention in an amount in the range from about 0.01% to about 1% by weight of the water therein. Individuals skilled in the art, with the benefit of this disclosure, will recognize the exact type and amount of crosslinker to use depending on factors such as the specific gelling agent, desired viscosity, and formation conditions.

The above-described gelled or gelled and cross-linked fracturing fluids typically also include internal delayed gel breakers such as those of the enzyme type, the oxidizing type, the acid buffer type, or the temperature-activated type. The gel breakers cause the viscous carrier fluids to revert to thin fluids that can be produced back to the surface after they have been. When used, s gel breaker is typically present in the carrier fluid in an amount in the range of from about 0.5% to about 10% by weight of the gelling agent. The carrier fluids may also include one or more of a variety of well-known additives, such as gel stabilizers, fluid loss control additives, clay stabilizers, bactericides, and the like.

Suitable flush fluids may be identical to the carrier fluids described above, or may be un-gelled (that is, not substantially viscous) fluids. Flush fluids may be either a hydrocarbon liquid or an aqueous liquid and a surfactant. In additional to delivering an organosilane coupling agent to a desired portion of a subterranean formation, the flush fluid may also act to preparing the subterranean formation for the later placement of the resin by removing oil and/or debris from the pore spaces within the formation matrix. In some preferred embodiments, the flush fluid is a brine. It is generally preferable to place the flush fluid into the desired portion of the subterranean formation at a matrix flow rate. As used herein, the term “matrix flow rate” means a flow rate which is high enough to allow the fluid to move through the matrix of particulates and the formation but below that which will form or enhance fractures in the formation.

The particulates used in accordance with the present invention are generally of a size such that formation particulate solids, which migrate with produced fluids, are prevented from being produced from the subterranean zone. Generally, suitable particulates are those that are commonly used as proppant or gravel, such as graded sand, bauxite, ceramic materials, glass materials, walnut hulls, polymer beads and the like. Generally, the suitable particulates have a size in the range of from about 2 to about 400 mesh, U.S. Sieve Series. The preferred particulates are graded sand having a particle size in the range of from about 10 to about 70 mesh, U.S. Sieve Series. Preferred sand particle size distribution ranges are one or more of 10-20 mesh, 20-40 mesh, 40-60 mesh or 50-70 mesh, depending on the particular size and distribution of formation solids to be screened out by the consolidated proppant particles.

### B. Organosilane Coupling Agents

Any organosilane coupling agent that is compatible with the hardenable resin and facilitates the coupling of the resin to the surface of an inorganic material (such as proppants or rock) is suitable for use in the present invention. Suitable organosilane coupling agents are molecules that include at least one silicone (Si) which contains both a functional group capable of attaching to an organic resin and a second functional group capable of attaching to an inorganic material or substrate to achieve a “coupling” effect. Examples of suitable organosilane coupling agents include, but are not limited to, N-2-(aminoethyl)-3-aminopropyltrimethoxysilane; 3-glycidoxypropyltrimethoxysilane; gamma-aminopropyltriethoxysilane; N-beta-(aminoethyl)-gamma-aminopropyltrimethoxysilanes, aminoethyl-N-beta-(aminoethyl)-gamma-aminopropyl-trimethoxysilanes; gamma-ureidopropyl-triethoxysilanes; beta-(3-4 epoxy-cyclohexyl)-ethyl-trimethoxysilane; and gamma-glycidoxypropyltrimethoxysilanes; vinyltrichlorosilane; vinyltris (beta-methoxyethoxy) silane; vinyltriethoxysilane; vinyltrimethoxysilane; 3-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-B (aminoethyl)-raminopropyl-trimethoxysilane; N-beta (aminoethyl)-raminopropylmethyldimethoxysilane; 3-aminopropyl-triethoxysilane; N-phenyl-r-aminopropyltrimethoxysilane; r-mercaptopropyltrimethoxysilane; Vinyltrichlorosilane; vinyltris (βmethoxyethoxy) silane; Vinyltrimethoxysilane; r-metacryloxypropyltrimethoxysilane; beta-(3,4 epoxycyclohexyl)-ethyltrimethoxysilane; r-glycidoxypropyltrimethoxysilane; r-glycidoxypropylmethylidiethoxysilane; N-beta (aminoethyl)-r-aminopropyltrimethoxysilane; N-beta (aminoethyl)-r-aminopropylmethyldimethoxysilane; r-aminopropyltriethoxysilane; N-phenyl-raminopropyltrimethoxysilane; r-mercaptopropyltrimethoxysilane; and combinations thereof.

Of these, n-beta-(aminoethyl)-gamma-aminopropyl trimethoxysilane may be preferred, particularly when the selected resin is an epoxy-based resin. One skilled in the art will recognize that choice of organosilane coupling agent, in particular the organic functional group, will effect the speed at which the agent acts to cure the chosen resin. The choice of the organosilane coupling agent may depend on the operation being performed; for instance, it may be desirable to choose an organosilane coupling agent that reacts more slowly with the selected resin in order to allow particulates to be placed into a desirable location before the resin completely cures. Similarly, one skilled in the art will recognize that choice of organosilane coupling agent, in particular the silane functional group, may be important in situations wherein the organosilane coupling agent is used in an aqueous-based fluid. In such situations, it may be desirable to choose an organosilane coupling agent that has a silane functional group that is relatively less reactive with water in order to ensure that the silane functional group remains available to provide connection to the desired proppant, particulates, or rock surfaces. In embodiments wherein an organosilane coupling agent is used as a part of an aqueous preflush treatment that is to be followed by a resin treatment, choice of an organosilane coupling agent having a silane functional group that is relatively less reactive with water is desirable.

In some embodiments, it may be desirable to mix the organosilane coupling agent with a solvent before use. In such cases, any aqueous solvent that does not otherwise adversely effect the desired treatment is acceptable. Examples of suitable solvents include brines, methanol, ethanol, isopropyl alcohol, and glycol ethers. A solvent may be desirable, among other times, when an organosilane coupling agent is to be directly coated onto the surfaces of dry particulates. In particular, where a low concentration of organosilane coupling agent is placed directly on the particulates (less than about 1% v/w), it is preferable to dilute the organosilane coupling agent with a solvent to enhance the coating distribution to all particulates. For example, instead of coating 0.5 mL of organosilane coupling agent directly on 100 grams of 20/40-mesh Brady sand, the volume of organosilane coupling agent may be first diluted with 2 to 5 mL of, for example, methanol. This dilution mixture may then be coated onto the dry proppant by any suitable means (such as mixing or blending). In this example, the methanol solvent will then evaporate from the surface of the proppant and leave behind a desired concentration of organosilane coupling agent coated on the sand. This is method may also be used to prepare the pre-coated sand or proppant that has been coated with the organosilane coupling agent.

### C. Suitable Hardenable Resins

The liquid hardenable resin of the present invention is comprised of a hardenable resin and, optionally, a solvent. In preferred embodiments, the solvent used has a high flash point, most preferably above about 125° F. When used, the solvent is added to the resin to reduce its viscosity for ease of handling, mixing, and transferring. It is within the ability of one skilled in the art, with the benefit of this disclosure, to determine if and how much of a solvent is needed to achieve a suitable viscosity. Optionally, the liquid hardenable resin can be heated to reduce its viscosity rather than using a solvent.

Examples of preferred hardenable resins include, but are not limited to, resins such as bisphenol A-epichlorohydrin resin, polyepoxide resin, novolak resin, polyester resin, phenol-aldehyde resin, urea-aldehyde resin, furan resin, urethane resin, glycidyl ethers and mixtures thereof. Of these, bisphenol A-epichlorohydrin resin is preferred.

One skilled in the art with the benefit of this disclosure will be able to select a combination of organosilane coupling agent and resin such that the organic portion of the organosilane coupling agent is capable of reacting with the selected hardenable resin. By way of example, when a bisphenol A epoxy resin is selected, N(beta-aminoethyl)gamma-aminopropyltrimethoxy-silane is a preferred organosilane coupling agent. By contrast, where a bisphenol A epoxy resin is selected, an organosilane coupling agent having an epoxy functional group would not be preferred.

Any solvent that is compatible with the hardenable resin and achieves the desired viscosity effect is suitable for use in the present invention. Preferred solvents are those having high flash points (most preferably about 125° F.). As described above, use of a solvent in the hardenable resin composition is optional but may be desirable to reduce the viscosity of the hardenable resin component for ease of handling, mixing, and transferring. It is within the ability of one skilled in the art with the benefit of this disclosure to determine if and how much solvent is needed to achieve a suitable viscosity. Solvents suitable for use in the present invention include, but are not limited to, butylglycidyl ether, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, d'limonene and fatty acid methyl esters. Of these, butylglucidyl ether is the preferred optional solvent. The amount of the solvent used in the liquid hardenable resin component is in the range of from about 0% to about 30% by weight of the liquid hardenable resin.

To facilitate a better understanding of the present invention, the following examples of certain aspects of some embodiments are given. In no way should the following examples be read to limit, or define, the scope of the invention.

### EXAMPLES

### Example 1

An organosilane coupling agent, Silquest A-1120, an N(beta-aminoethyl)gamma-aminopropyltrimethoxy-silane organosilane coupling agent commercially available from Momentive Performance Materials Inc. of Wilton, Conn., was first diluted in methanol by mixing 1 milliliter of the organosilane coupling agent with 3 cc of methanol. The diluted organosilane coupling agent was then dry coated onto two hundred grams of 20/40-mesh Brady sand in an amount of 0.5 ml of diluted organosilane coupling agent per 100 grams of sand to create coated sand.

Next, a water-based epoxy resin was prepared by mixing 4.5 milliliters of Epi-Res 3510-W-60 (a nonionic, aqueous dispersion of a bisphenol A epoxy resin), a water-based hardenable resin emulsion commercially available from Hexion Specialty Chemicals, Inc. of Columbus, Ohio, with 5.5 milliliters of tap water. The coated sand was then dry-coated with 6 milliliters of the water-based epoxy resin and then packed into a brass cell having dimensions of 1.375-inch in diameter and 5.5-inches in length. The packed cell was then placed in an oven and allowed to cure for 24-hours at 200° F.

After 24-hours had passed, the cell was removed from the oven and allowed to cool. The result was a consolidated sand pack which was then cut into cores. The values of their unconfined compressive strengths were 2.16 and 244 psi, and their average UCS was 230 psi.

### Example 2

An organosilane coupling agent, Silquest A-1120 was first diluted in methanol by mixing 1 milliliter of the organosilane coupling agent with 3 cc of methanol. The diluted organosilane coupling agent was then dry coated onto two hundred grams of 20/40-mesh Brady sand in an amount of 0.5 ml of diluted organosilane coupling agent per 100 grams of sand to create coated sand. Next, a non-emulsified epoxy resin was prepared by mixing 0.1 mL of an ethoxylated nonyl phenol phosphate ester with 3 mL of an epoxy hardenable resin component. Two milliliters of the resin mixture was then dry coated onto 200 grams of the organosilane-coated sand. The twice-coated sand was then poured into a plastic beaker containing 500 milliliters of water and the water was stirred with an overhead stirrer to form a sand slurry. After stirring for 30 seconds, most of the water was decanted and the remaining slurry was packed into a brass cell having the same dimension as that described in Example 1. The packed cell was then placed in an oven and allowed to cure for 24-hours at 200° F.

After 24-hours had passed, the cell was removed from the oven and allowed to cool. The result was a consolidated sand pack which was then cut into cores. The values of their unconfined compressive strengths were 158 and 172 psi, and their average UCS was 165 psi.

### Example 3

An organosilane coupling agent, Silquest A-1120 was first diluted in methanol by mixing 1 milliliter of the organosilane coupling agent with 3 cc of methanol. The diluted organosilane coupling agent was then dry coated onto two hundred grams of 20/40-mesh Brady sand in an amount of 0.5 ml of diluted organosilane coupling agent per 100 grams of sand to create coated sand. Next, 500 milliliters of water was placed into a beaker and stirred with an overhead stirrer. Next, 0.5 mL of ES-5, a cationic surfactant commercially available from Halliburton Energy Services, Inc. of Duncan, Okla., was added to the water and then the coated sand was added to the water, which continued to be stirred, thus creating a slurry. Next, 3 mL of Expedite 225 Component A, an epoxy based curable resin commercially available from Halliburton Energy Services, Inc., Duncan, Okla., was slowly added to the stirring water. After stirring for 30 additional seconds, most of the water was decanted and the remaining slurry was packed into a brass cell having the same dimension as that described in Example 1. The packed cell was then placed in an oven and allowed to cure for 24-hours at 200° F.

After 24-hours had passed, the cell was removed from the oven and allowed to cool. The result was a consolidated sand pack which was then cut into cores. The values of their unconfined compressive strengths (UCS) were 16 and 24 psi, and their average UCS was 20 psi.

### Example 4

About 200 grams of 20/40-mesh Brady sand were dry packed into a brass cell which has dimensions of 1.5 inches inside diameter and 5 inches in length. Wire screens of 60-mesh were installed at the bottom and top of the sand pack to keep the sand particulates in place during injection of treatment fluids into the sand pack. A volume of 150 mL of preflush fluid of 3% KCl brine containing 0.5% (v/v) 19N, a quaternary ammonium cationic surfactant, to enhance the wetting of the resin onto the sand surface was injected into sand pack at an injection rate of 20 mL/min. Following the injection of preflush fluid, a volume of 100 mL of an aqueous-based fluid of 3% KCl brine containing 6% (w/v) of Hexion Epi-Res 3510-W-60 water-based resin emulsion and 5% (v/v) of SilQuest A-1120 organosilane coupling agent was injected into the sand pack also at 20 mL/min. A post-flush of nitrogen gas at flow rate 12 L/min was then injected into the treated sand pack for 3 minutes to remove excess resin from occupying the pore spaces in the sand pack matrix. The packed cell was then sealed and cured in oven at 200° F. for 20 hours. After curing period, the consolidated sand pack was removed from the cell and cut into cores for unconfined compressive strength measurements. The UCS values of these cores were 11 and 24 psi.

### Example 5

Similar procedures were performed as in Example 4, except that the preflush fluid did not contain the 19N quaternary ammonium cationic surfactant. The UCS values of these cores were 25 and 35.

### Example 6

Similar procedures were performed as in Example 4, except that the preflush fluid did not contain the 19N quaternary ammonium cationic surfactant, but it contained 0.5% (v/v) of Silquest A-1120 organosilane coupling agent. The UCS values of these cores were 21 and 35.

Therefore, the present invention is well adapted to attain the ends and advantages mentioned as well as those that are inherent therein. The particular embodiments disclosed above are illustrative only, as the present invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular illustrative embodiments disclosed above may be altered or modified and all such variations are considered within the scope and spirit of the present invention. All numbers and ranges disclosed above may vary by some amount. Whenever a numerical range with a lower limit and an upper limit is disclosed, any number and any included range falling within the range is specifically disclosed. In particular, every range of values (of the form, “from about a to about b,” or, equivalently, “from approximately a to b,” or, equivalently, “from approximately a-b”) disclosed herein is to be understood to set forth every number and range encompassed within the broader range of values. Moreover, the indefinite articles “a” or “an”, as used in the claims, are defined herein to mean one or more than one of the element that it introduces. Also, the terms in the claims have their plain, ordinary meaning unless otherwise explicitly and clearly defined by the patentee.

What is claimed is:

1. A method of using particulates with a resin coating capable of hardening in a subterranean operation comprising the steps of:
providing particulates, an organosilane coupling agent, a carrier fluid, and a curable resin, wherein the curable resin requires an external hardening agent in order to cure;
coating the particulates with the organosilane coupling agent to create organosilane-coated particulates;
coating the organosilane-coated particulates with the curable resin to create hardenable resin-coated particulates;
creating a slurry of hardenable resin-coated particulates in the carrier fluid; and,
placing the slurry into a portion of a subterranean formation and allowing the organosilane coupling agent to cure the hardenable resin to form cured, resin-coated particulates.

2. The method of claim 1 wherein the organosilane coupling agent is coated onto the particulates in an amount less than about 2% volume/weight of the particulates.

3. The method of claim 1 wherein the curable resin is coated onto the particulates in an amount less than about 5% volume/weight of the particulates.

4. The method of claim 1 wherein the curable resin is an organic resin comprising bisphenol A-epichlorohydrin resin, polyepoxide resin, novolak resin, polyester resin, phenol-aldehyde resin, urea-aldehyde resin, furan resin, urethane resin, glycidyl ethers, or mixtures thereof.

5. The method of claim 1 wherein the curable resin further comprises a solvent.

6. The method of claim 5 wherein the solvent comprises butylglycidyl ether, dipropylene glycol methyl ether, dipropylene glycol dimethyl ether, dimethyl formamide, diethyleneglycol methyl ether, ethyleneglycol butyl ether, diethyleneglycol butyl ether, propylene carbonate, d'limonene, fatty acid methyl esters, or mixtures thereof.

7. The method of claim 1 wherein the organosilane coupling agent further comprises a solvent.

8. The method of claim 7 wherein the solvent comprises a brine, methanol, ethanol, isopropyl alcohol, a glycol ether, or mixtures thereof.

9. A method of consolidating particulates with a resin coating capable of hardening in a subterranean environment comprising the steps of:
providing particulates, an organosilane coupling agent, a carrier fluid, and a curable resin, wherein the curable resin requires an external hardening agent in order to cure;
coating the particulates with the organosilane coupling agent to create organosilane-coated particulates;
creating a slurry of organosilane-coated particulates in the carrier fluid wherein the carrier fluid comprises the curable resin and allowing the organosilane coupling agent to preferentially attract the curable resin to the organosilane-coated particulates;
placing the slurry into a portion of a subterranean formation and allowing the organosilane coupling agent to cure the hardenable resin to form cured, resin-coated particulates.

10. The method of claim 9 wherein the organosilane coupling agent is coated onto the particulates in an amount less than about 2% volume/weight of the particulates.

11. The method of claim 9 wherein the curable resin is included in the carrier fluid in an amount less than about 5% volume/weight of the particulates.

12. The method of claim 9 wherein the curable resin is an organic resin comprising bisphenol A-epichlorohydrin resin, polyepoxide resin, novolak resin, polyester resin, phenol-aldehyde resin, urea-aldehyde resin, furan resin, urethane resin, glycidyl ethers, or mixtures thereof.

13. The method of claim 9 wherein the organosilane coupling agent further comprises a solvent.

14. The method of claim 13 wherein the solvent comprises a brine, methanol, ethanol, isopropyl alcohol, a glycol ether, or mixtures thereof.

15. A method of consolidating particulates within a portion of a subterranean formation comprising the steps of:
placing a first flush fluid comprising an organosilane coupling agent into a portion of a subterranean formation comprising particulates and allowing the organosilane coupling agent to coat at least a portion of the particulates;
placing a second flush fluid comprising a curable resin, wherein the curable resin requires an external hardening agent in order to cure, into at least a portion of the subterranean formation where the first flush fluid was previously placed;
allowing the organosilane coupling agent to attract the curable resin and to cure the curable resin on the particulate surfaces within the subterranean formation to form cured, resin-coated particulates.

16. The method of claim 15 wherein the organosilane coupling agent is included in the first flush fluid in an amount less than about 3% volume/volume of the first flush fluid.

17. The method of claim 15 wherein the curable resin is included in the second flush fluid in an amount less than about 10% volume/volume of the second flush fluid.

18. The method of claim 15 wherein the curable resin is an organic resin comprising bisphenol A-epichlorohydrin resin, polyepoxide resin, novolak resin, polyester resin, phenol-aldehyde resin, urea-aldehyde resin, furan resin, urethane resin, glycidyl ethers, or mixtures thereof.
